(19) United States
(12) Patent Application Publication
(10) Pub. No.: US 2026/0103544 A1
(43) Pub. Date: Apr. 16, 2026

(54) FUNCTIONAL BACTERIAL NANOCELLULOSE FILM AND ITS PREPARING METHOD

(71) Applicant: KOREA RESEARCH INSTITUTE OF CHEMICAL TECHNOLOGY, Daejeon (KR)

(72) Inventors: Ji Hoon SHIN, Daejeon (KR); Se Young KIM, Daejeon (KR); Sae Hume PARK, Daejeon (KR); Hyunho LEE, Daejeon (KR)

(21) Appl. No.: 19/321,386

(22) Filed: Sep. 8, 2025

(30) Foreign Application Priority Data
Oct. 11, 2024 (KR) 10-2024-0138814

(51) Int. Cl. C08B 15/08; C08J 5/18; C08J 7/06

(52) U.S. Cl. CPC C08B 15/08; C08J 5/18; C08J 7/065; C08J 2301/02

(57) ABSTRACT

The present disclosure relates to a functional bacterial nanocellulose film and a method for preparing the same, and provides a functional bacterial nanocellulose film in which the coating of berberine chloride on the bacterial nanocellulose film reduces oxygen permeability and water vapor permeability, while enhancing ultraviolet blocking ability and antibacterial properties.

### CROSS-REFERENCE TO RELATED APPLICATION

This application claims priority to Korean Patent Application No. 10-2024-0138814 filed on Oct. 11, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a functional nanocellulose film and a method for preparing the same.

### Description of the Related Art

Cellulose is the most abundant natural polymer in the world and is a polymer composed of long chains of monosaccharide units linked by glycosidic bonds. Cellulose can be obtained from naturally derived materials, making it sustainable, and it has characteristics such as biodegradability, biocompatibility, and non-toxicity, which have led to active research on its applications. Cellulose can be obtained from woody plants such as trees, herbaceous plants such as cotton, animals such as tunicates, and bacteria. While cellulose obtained from woody plants, herbaceous plants, and animals is produced through a top-down approach, cellulose obtained from bacteria is produced through a bottom-up approach. Nanocellulose refers to cellulose fibers with a length or width of less than 100 nm. Based on a fiber length of approximately 700 nm, if the fiber is shorter than this, it is called cellulose nanocrystal (CNC), whereas if the length of fiber is longer than approximately 700 nm, it is called cellulose nanofiber (CNF). Research on the applications of nanocellulose is actively being conducted in various fields, including cosmetics.

Bacterial cellulose is characterized by its high aspect ratio and crystallinity, resulting in superior mechanical properties, and unlike cellulose derived from woody plants, it is composed almost entirely of cellulose without secondary substances such as hemicellulose and lignin. Bacterial cellulose refers to cellulose synthesized by bacteria through the absorption of monosaccharides such as glucose. Although the cellulose synthesized in this manner is on the nanoscale, the fiber width is uneven, approximately 20 nm to 100 nm, which requires mechanical or chemical treatment to produce a uniform structure. Bacterial cellulose produced in a uniform form exhibits a higher aspect ratio and superior mechanical properties compared to cellulose obtained from woody plants.

When producing CNFs with a uniform morphology, numerous methods are available, but the most representative method is TEMPO oxidation. TEMPO oxidation is also referred to as the 2,2,6,6-tetramethylpiperidine-1-oxyl radical (TEMPO)/NaClO/sodium bromide (NaBr) system. When this reaction is carried out at pH 10-11, the hydroxyl group at the C6 position of cellulose is selectively oxidized to a carboxylate salt (—COO⁻Na⁺), imparting negative charges to the fiber surface. Subsequently, by using equipment such as a high-pressure homogenizer or an ultrasonicator, the hydrogen bonding between cellulose fibers is offset by these surface negative charges, thereby uniformly nanosizing the cellulose into nanofibers. Consequently, CNFs that are uniformly dispersed in water can ultimately be obtained.

The TEMPO/NaClO/NaBr system can be replaced with a simpler process that uses minimal chemicals, namely electron beam irradiation (EBI) and high-pressure homogenization (HPH). Electron beam irradiation involves bombarding the sample with high-energy electrons. When electron beams are applied to polymeric materials, they not only exhibit a sterilization effect by eliminating microorganisms but can also cleave or cross-link polymer chains, as well as modify the surface of the polymers. According to recent studies, by oxidizing the OH groups of polysaccharides into carboxyl groups through electron beam treatment, followed by high-pressure homogenization, it is possible to produce nanostructured polysaccharides that are transparently dispersed in water, similar to the outcome of TEMPO oxidation. However, films produced using bacterial nanocellulose prepared by this method have low water vapor resistance, which has limited their applications.

Meanwhile, berberine chloride (BB) is a compound belonging to protoberberines, a subclass of benzylisoquinoline alkaloids, and is characterized by the presence of a quaternary ammonium salt. Berberine chloride is a raw material that can be obtained from various plants, including berberis. Berberine chloride exists as a yellow crystalline powder and is used as both a medicinal material and a dye.

Considering these aspects, the inventors have developed the present disclosure by preparing a functional nanocellulose film coated with berberine chloride on a bacterial nanocellulose film derived from bacterial cellulose and demonstrating its excellent functionalities.

### RELATED PATENT DOCUMENT

Korean Registered Patent Publication No. 10-1973758 (Published on Oct. 17, 2019

### SUMMARY OF THE DISCLOSURE

One purpose of the present disclosure is to provide a functional nanocellulose film and a method for preparing the same.

Another purpose of the present disclosure is to provide a functional packaging material using the functional nanocellulose film.

The challenges that the present disclosure is intended to solve are not limited to those mentioned above, and other challenges not mentioned will be apparent to those skilled in the art from the following description.

In order to achieve the purpose, an aspect of the present disclosure provides a method for preparing a functional nanocellulose film, the method comprising:
(a) producing bacterial nanocellulose by subjecting bacterial cellulose to electron beam irradiation and high-pressure homogenization;
(b) producing a nanocellulose film from the bacterial nanocellulose produced in step (a); and
(c) coating berberine chloride on the nanocellulose film produced in step (b).

In some exemplary embodiments, the bacterial cellulose may be obtained using Nata de coco.

In some exemplary embodiments, step (c) may comprise immersing the nanocellulose film in an aqueous solution of berberine chloride.

In some exemplary embodiments, the aqueous solution of berberine chloride may have a concentration of 0.1 to 10 g/L, and the immersing may be performed for 10 to 40 hours.

In some exemplary embodiments, in step (c), an electrostatic interaction may be formed between carboxyl groups of the nanocellulose film and a quaternary ammonium group of berberine chloride.

In some exemplary embodiments, wherein the nanocellulose may be represented by Chemical Formula 1, and the berberine chloride may be represented by Chemical Formula 2.

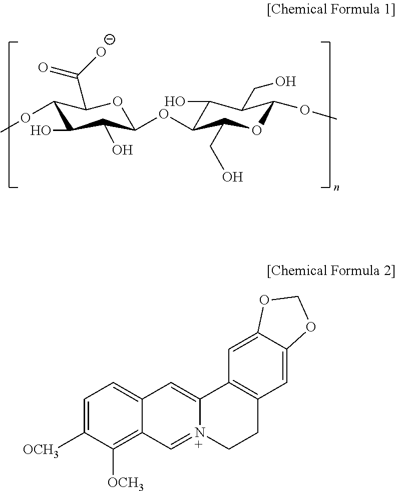

In addition, another aspect of the present disclosure provides a functional nanocellulose film comprising a nanocellulose film coated with berberine chloride.

In some exemplary embodiments, the functional nanocellulose film may have a porosity reduced in comparison to that of the nanocellulose film before being coated with the berberine chloride.

In some exemplary embodiments, the functional nanocellulose film may have strain and stress that are increased in comparison to those of the nanocellulose film before being coated with the berberine chloride.

In some exemplary embodiments, the functional nanocellulose film may have oxygen permeability and water vapor permeability that are decreased in comparison to those of the nanocellulose film before being coated with the berberine chloride.

In some exemplary embodiments, the functional nanocellulose film may have ultraviolet transmittance that is decreased in comparison to that of the nanocellulose film before being coated with the berberine chloride.

In some exemplary embodiments, the functional nanocellulose film may have antibacterial activity that is increased in comparison to that of the nanocellulose film before being coated with the berberine chloride.

In addition, another aspect of the present disclosure provides a functional packaging material comprising the functional nanocellulose film as described above.

In some exemplary embodiments, the functional packaging material may be for food packaging use.

In some exemplary embodiments, the functional packaging material is for ultraviolet blocking use.

According to the present disclosure, a functional nanocellulose film coated with berberine chloride and a method for preparing the same are provided.

In addition, the present disclosure provides a functional packaging material comprising the nanocellulose film.

Furthermore, according to the present disclosure, the functional nanocellulose film and the functional packaging material comprising the same exhibit reduced oxygen permeability and water vapor permeability, and improved ultraviolet blocking ability and antibacterial activity, compared to those of the nanocellulose film before being coated with berberine chloride.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a process flow diagram illustrating a method for preparing a functional nanocellulose film according to an exemplary embodiment of the present disclosure.

FIG. 2 is a schematic diagram illustrating a method for producing bacterial nanocellulose according to an exemplary embodiment of the present disclosure.

FIG. 3 includes (a) a schematic diagram illustrating a method for preparing a bacterial nanocellulose film from bacterial nanocellulose and (b) a photograph of the film prepared by the method, according to an exemplary embodiment of the present disclosure.

FIG. 4 is a schematic diagram illustrating a method for preparing a functional nanocellulose film by immersing the bacterial nanocellulose film in an aqueous solution of berberine chloride, according to an exemplary embodiment of the present disclosure.

FIG. 5 shows FT-IR results of a BCNF-E050 film, a BCNF-E050/BB film, and berberine chloride, according to an exemplary embodiment of the present disclosure.

FIG. 6 shows surface and cross-sectional SEM images of the BCNF-E050 film and the BCNF-E050/BB film according to an exemplary embodiment of the present disclosure.

FIG. 7 shows surface morphology and roughness results of the BCNF-E050 film and the BCNF-E050/BB film observed using AFM, according to an exemplary embodiment of the present disclosure.

FIG. 8 is a graph showing the mechanical properties of the BCNF-E050 film and the BCNF-E050/BB film according to an exemplary embodiment of the present disclosure.

FIG. 9 shows XRD and TGA graphs of the BCNF-E050 film and the BCNF-E050/BB film according to an exemplary embodiment of the present disclosure.

FIG. 10 compares the water contact angles of the BCNF-E050 film and the BCNF-E050/BB film according to an exemplary embodiment of the present disclosure.

FIG. 11 shows graphs of oxygen permeability and water vapor permeability of the BCNF-E050 film and the BCNF-E050/BB film according to an exemplary embodiment of the present disclosure.

FIG. 12 includes (a) graphs of UV-blocking performance and light transmittance of the BCNF-E050 film and the BCNF-E050/BB film, and (b) a method for confirming UV-blocking performance using a UV test card, according to an exemplary embodiment of the present disclosure.

FIG. 13 shows results of UV-blocking performance tested using artificial skin for the BCNF-E050 film and the BCNF-E050/BB film according to an exemplary embodiment of the present disclosure.

FIG. 14 shows antibacterial properties of the BCNF-E050 film and the BCNF-E050/BB film according to an exemplary embodiment of the present disclosure.

FIG. 15 shows the appearance of apples wrapped with the BCNF-E050 film and the BCNF-E050/BB film in food packaging applications according to an exemplary embodiment of the present disclosure.

FIG. 16 compares the weight change of apples wrapped with the BCNF-E050 film and the BCNF-E050/BB film in food packaging applications according to an exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

### Method for Preparing a Functional Bacterial Nanocellulose Film

The present disclosure provides a method for preparing a functional bacterial nanocellulose film, the method comprising:
a first step of producing bacterial nanocellulose by subjecting bacterial cellulose to electron beam irradiation and high-pressure homogenization;
a second step of preparing a film from the bacterial nanocellulose; and
a third step of coating the bacterial nanocellulose film with berberine chloride.

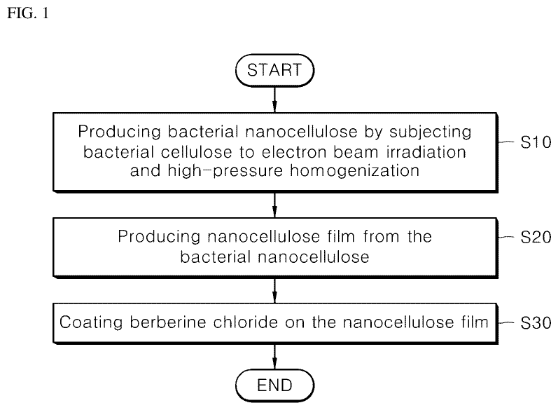

FIG. 1 is a process flow diagram illustrating a method for preparing a functional nanocellulose film according to an exemplary embodiment of the present disclosure. With reference to FIG. 1, each step will be described in detail below.

(a) Bacterial nanocellulose is produced by subjecting bacterial cellulose to electron beam irradiation and high-pressure homogenization (S10).

Bacterial cellulose refers to cellulose produced by bacteria, which synthesize cellulose by absorbing monosaccharides such as glucose or fructose from a medium containing carbon and nitrogen sources. This type of bacterial cellulose is characterized by a high aspect ratio and high crystallinity, resulting in superior mechanical properties. Unlike cellulose obtained from woody plants, bacterial cellulose is composed almost entirely of pure cellulose, with little to no secondary components such as hemicellulose and lignin. Although bacterial cellulose is synthesized at the nanoscale by the bacteria, the fiber width is non-uniform, typically ranging from about 20 to 100 nm. Therefore, mechanical or chemical treatment is required to produce a uniform form. Bacterial cellulose fabricated into a uniform form exhibits a higher aspect ratio and improved mechanical properties compared to cellulose derived from woody sources.

The bacterial cellulose according to the present disclosure may be obtained using nata de coco, but is not limited thereto. Nata de coco is a jelly-like product derived from coconut and may be produced using coconut milk, acetic acid, and bacteria. Preferably, the bacterial cellulose according to the present disclosure is a purified form of nata de coco from which bacteria and other additives have been removed.

In the present disclosure, nanocellulose refers to cellulose having a fiber length or width of 100 nm or less. When the fiber length exceeds approximately 700 nm, the nanocellulose is referred to as cellulose nanofiber (CNF), and such cellulose nanofiber is included in the nanocellulose of the present disclosure.

In the prior art, the most representative method for producing CNFs with a uniform morphology is TEMPO oxidation (TEMPO/NaClO/NaBr system). In this method, cellulose is uniformly nanofibrillated into nanocellulose fibers, thereby allowing CNFs to be ultimately obtained in a form uniformly dispersed in water. However, the TEMPO oxidation method has limitations in that it requires the use of various chemical substances and generates a large amount of wastewater for their removal.

Accordingly, in the present disclosure, to replace TEMPO oxidation, bacterial cellulose nanofiber (BCNF) having a uniform nanoscale size is produced by subjecting bacterial cellulose to electron beam irradiation (EBI) and high-pressure homogenization (HPH). Specifically, oxidation of hydroxyl (—OH) groups in cellulose can be induced by electron beam irradiation, and subsequently, high-pressure homogenization may be performed to ultimately produce BCNF with a uniform nanoscale size.

Preferably, the bacterial cellulose obtained through a purification process as described above is subjected to electron beam irradiation in a wet condition, followed by high-pressure homogenization to produce a transparent suspension of bacterial cellulose nanofiber (BCNF) (FIG. 2).

The electron beam irradiation may selectively oxidize the hydroxyl (—OH) group at the C6 position of the cellulose to a carboxyl (—COOH) group. Through such oxidation, the cellulose surface may acquire a charge, thereby enabling dispersion in an aqueous solution.

The electron beam may have a dose ranging from 10 to 500 kGy, and preferably from 50 to 300 kGy.

When the dose exceeds the maximum value, the length of the bacterial nanocellulose may become too short due to the electron beam, resulting in brittleness when formed into a film.

On the other hand, when the dose is below the minimum value, the number of carboxyl groups introduced by the electron beam may be insufficient, resulting in poor dispersion of the final bacterial cellulose nanofiber (BCNF) in water.

The high-pressure homogenization may be performed on the electron beam-irradiated bacterial cellulose under alkaline conditions using a high-pressure homogenizer.

Through such electron beam irradiation and high-pressure homogenization, a transparent bacterial cellulose nanofiber (BCNF) uniformly dispersed in water may be produced.

The bacterial cellulose nanofiber (BCNF) suspension prepared as described above may be spray-dried, and the spray-dried bacterial cellulose nanofiber powder may be redispersible in water.

(b) A film is prepared from the bacterial nanocellulose produced in step S10 (S20).

Step S20 may be performed by filtering and drying the bacterial nanocellulose produced in step S10.

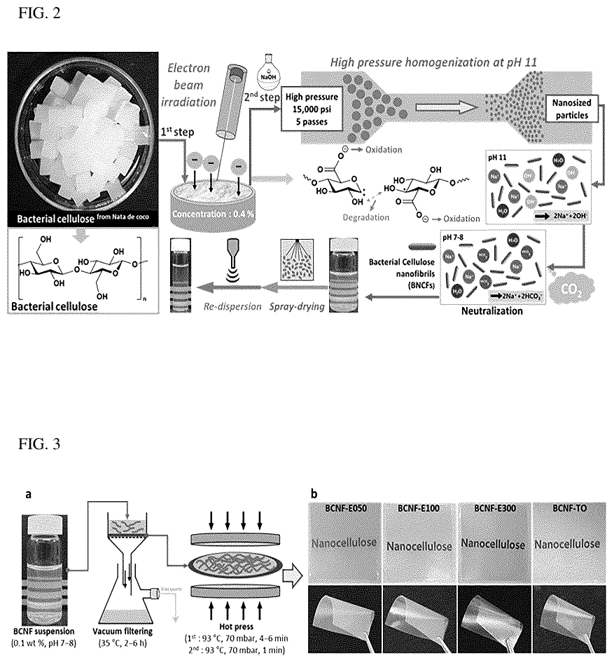

Specifically, the bacterial nanocellulose suspension produced in step S10 may be filtered to form a cake-like bacterial nanocellulose, which may then be dried. The filtration may be vacuum filtration, and the drying may be performed using a hot press, but is not limited thereto (FIG. 3).
(c) The bacterial nanocellulose film prepared in step S20 is coated with berberine chloride (S30).

Step S30 may include immersing the film prepared in step S20 in an aqueous solution of berberine chloride to induce a reaction, thereby coating the bacterial nanocellulose film with berberine chloride.

Berberine chloride (BB) is a compound belonging to protoberberines, a subclass of benzylisoquinoline alkaloids, and is characterized by the presence of a quaternary ammonium salt.

The aqueous solution of berberine chloride may have a concentration of 0.1 to 10 g/L, and the immersion may be carried out for 10 to 40 hours.

Preferably, the aqueous solution of berberine chloride has a concentration of 0.5 to 5 g/L, and the immersion is performed for 15 to 35 hours.

In an exemplary embodiment of the present disclosure, the aqueous solution of berberine chloride was prepared at a concentration of 1 g/L, and the immersion was carried out for 24 hours.

By immersing the film in the aqueous solution of berberine chloride and allowing it to react, an electrostatic interaction may be formed between the carboxyl groups of the nanocellulose film and the quaternary ammonium group of berberine chloride.

The nanocellulose may be represented by Chemical Formula 1, and the berberine chloride may be represented by Chemical Formula 2.

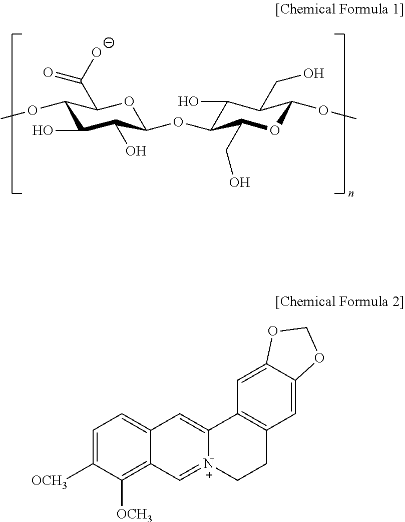

The average viscosity degree of polymerization (DPᵥ) of the nanocellulose may range from 30 to 500, and preferably from 40 to 400, or from 50 to 350.

Meanwhile, in Chemical Formula 1, n may be a positive integer.

### Functional Nanocellulose Film

The present disclosure provides a functional nanocellulose film in which berberine chloride is coated on a nanocellulose film.

Specifically, the functional nanocellulose film may be prepared by the method for preparing a functional nanocellulose film as described above, but is not limited thereto.

For example, the functional nanocellulose film of the present disclosure also includes a nanocellulose film prepared by coating berberine chloride as described in step (c) on a nanocellulose film that is produced by a method other than the above-described step (a) and step (b).

The nanocellulose film may be derived from bacterial cellulose, but is not limited thereto.

Although bacterial cellulose has advantages for preparing nanocellulose films as described above, the functional nanocellulose film according to the present disclosure may also be prepared using cellulose derived from other sources.

The functional nanocellulose film may have a reduced porosity compared to the nanocellulose film before coating with berberine chloride.

Referring to an exemplary embodiment of the present disclosure, the functional nanocellulose film according to the present disclosure exhibited a smoother surface and reduced porosity due to the coating of berberine chloride on the nanocellulose film.

In addition, it was confirmed that the surface roughness of the nanocellulose film was reduced.

Meanwhile, the fact that the density of the film was maintained even after the berberine chloride coating suggests that the berberine chloride is primarily present on the surface of the film.

The functional nanocellulose film may exhibit increased strain and stress compared to the nanocellulose film before coating with berberine chloride.

Referring to an exemplary embodiment of the present disclosure, the functional nanocellulose film according to the present disclosure showed enhanced mechanical properties, as the strain and stress increased due to the coating of berberine chloride.

It was also confirmed that the crystallinity and thermal stability of the film were maintained even after the berberine chloride coating.

The functional nanocellulose film may exhibit increased hydrophobicity compared to the nanocellulose film before coating with berberine chloride.

Referring to an exemplary embodiment of the present disclosure, it was confirmed that the functional nanocellulose film according to the present disclosure showed increased moisture resistance (hydrophobicity) as a result of berberine chloride coating, as evidenced by an increase in contact angle.

The functional nanocellulose film may exhibit reduced oxygen permeability and water vapor permeability compared to the nanocellulose film before coating with berberine chloride.

Referring to an exemplary embodiment of the present disclosure, it was confirmed that the functional nanocellulose film according to the present disclosure showed decreased oxygen and water vapor permeability as a result of berberine chloride coating.

This may be attributed to the berberine chloride filling the pores of the nanocellulose film and enhancing its hydrophobicity.

The functional nanocellulose film may exhibit reduced ultraviolet transmittance compared to the nanocellulose film before coating with berberine chloride.

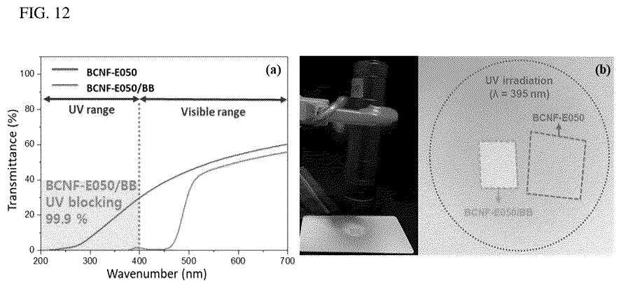

In particular, the functional nanocellulose film is characterized by reduced ultraviolet transmittance while maintaining transmittance in a portion of the visible light region (500-700 nm) [FIG. 12(a)].

Referring to an exemplary embodiment of the present disclosure, the functional nanocellulose film according to the present disclosure may increase ultraviolet blocking efficiency by coating with berberine chloride, while maintaining light transmittance and thereby not affecting transparency.

The ultraviolet blocking efficiency may be 92% or more, 93% or more, or 95% or more, and preferably may be improved to 99% or more.

In addition, to verify the ultraviolet blocking performance of the functional nanocellulose film according to the present disclosure, experiments were conducted using a UV test card and artificial skin.

As a result, the nanocellulose film coated with berberine chloride did not allow ultraviolet rays to pass through, and the epidermal layer of the artificial skin was maintained, thereby demonstrating the UV-blocking capability.

The functional nanocellulose film may exhibit increased antibacterial activity compared to the nanocellulose film before coating with berberine chloride.

Referring to an exemplary embodiment of the present disclosure, the functional nanocellulose film according to the present disclosure showed enhanced antibacterial activity against both gram-positive bacteria and gram-negative bacteria due to the berberine chloride coating.

The antibacterial activity may be 90% or more, 92% or more, 93% or more, or 95% or more, and preferably may be improved to 99% or more.

The functional nanocellulose film may be used for functional packaging applications.

As described above, the functional nanocellulose film according to the present disclosure, due to the coating of berberine chloride, exhibits improved mechanical properties, increased moisture resistance (hydrophobicity), excellent oxygen and water vapor barrier properties, ultraviolet blocking performance, and antibacterial activity, while maintaining crystallinity, enhanced thermal stability, and transparency.

Accordingly, it was confirmed that the film can be used in various functional packaging applications.

For example, the functional packaging material may be used for packaging fruits or food products, but is not limited thereto.

The functional nanocellulose film may be used for food packaging applications.

As described above, the functional nanocellulose film of the present disclosure, which exhibits excellent oxygen barrier, water vapor barrier, ultraviolet blocking, and antibacterial properties, is suitable for food preservation and preferably may be used as a food packaging material.

The functional nanocellulose film may be used for ultraviolet (UV) blocking applications.

As described above, in addition to excellent oxygen barrier, water vapor barrier, and antibacterial properties, the functional nanocellulose film exhibits outstanding ultraviolet blocking performance, showing a UV blocking efficiency of up to 99.9%.

Accordingly, the film is preferably used for ultraviolet blocking applications.

### Functional Packaging Material

The present disclosure provides a functional packaging material comprising the functional nanocellulose film described above.

The above-described functional nanocellulose film, through coating with berberine chloride, exhibits improved mechanical properties, increased moisture resistance (hydrophobicity), excellent oxygen and water vapor barrier properties, ultraviolet blocking performance, and antibacterial activity, while maintaining crystallinity, enhancing thermal stability, and retaining transparency.

Accordingly, it can be applied to various types of functional packaging materials.

In particular, the functional packaging material may be used for food packaging or ultraviolet blocking applications.

### Exemplary Embodiments

Hereinafter, the present disclosure will be described in further detail with reference to exemplary embodiments. However, the exemplary embodiments according to the present disclosure may be modified in various other forms, and the scope of the present disclosure should not be construed as being limited to the following exemplary embodiments.

The exemplary embodiments of the present disclosure are provided merely to more fully illustrate the present disclosure to those skilled in the art.

### 1. Materials

Bacterial cellulose was obtained using nata de coco (food-grade, 10×10 mm, VIETNAM COCO FOOD COMPANY, Vietnam).

Sodium hydroxide (NaOH, 1 M), sodium bromide (NaBr, 99%), and hydrochloric acid (HCl, 1 N) were purchased from DAEJUNG CHEMICALS & METALS (Republic of Korea).

2,2,6,6-Tetramethylpiperidin-1-oxyl (TEMPO, J & H CHEM, China) and sodium hypochlorite (NaClO, 8%, JUNSEI Chemical, Japan) were used without further purification to prepare TEMPO-oxidized bacterial cellulose nanofiber (BCNF-TO).

Potassium bromide (KBr, Sigma-Aldrich, USA) was used for Fourier transform infrared spectroscopy (FT-IR) analysis of the BC structure after electron beam or TEMPO oxidation treatment.

To analyze the molecular weight change of BC induced by electron beam irradiation, a 1 M cupriethylenediamine (CED) aqueous solution was used.

In addition, calcium chloride (anhydrous, 93%, CaCl₂), Alfa Aesar, USA) was used to measure the water vapor permeability of the BCNF film.

### 2. Preparation of Bacterial Cellulose Nanofibers (BCNFs)

### 2-1. Purification of BC

Bacterial cellulose (nata de coco) was purified to obtain pure bacterial cellulose (Paakkonen et al., 2019).

A total of 2.4 kg of nata de coco (containing 9.6 g of solids) was washed with 7.2 L of distilled water. The washed nata de coco was then placed in a 10 L round-bottom flask and mixed with 0.1 M sodium hydroxide (NaOH) at a concentration of 1 g/L.

The mixture was stirred at 200 rpm and heated at 80° C. for 3 hours.

After heating, the NaOH solution and nata de coco were separated using a mesh screen with 1 mm pore size. The separated nata de coco was then mixed with distilled water at a weight ratio of 1:2 and stirred for 5 hours.

After stirring, the nata de coco and water were separated again using the mesh screen, and fresh distilled water was added. This washing process was repeated five times.

The thoroughly washed and purified nata de coco was obtained in hydrogel form and referred to as bacterial cellulose (BC).

### 2-2. Electron Beam Irradiation (EBI) and High-Pressure Homogenization of BC (FIG. 2)

BC was subjected to degradation and oxidation using electron beam irradiation (EBI). Specifically, BC was mixed with water to a concentration of 0.4 wt %, and the mixture was placed in a 50×70 cm zipper bag such that the thickness did not exceed 15 mm.

The zipper bag was then transferred to a 80×80 cm metal carrier and placed on a conveyor belt passing through an electron accelerator. EBI was conducted at doses of 50, 100, and 300 kGy. The ELV-4 accelerator at EBTECH Co., LTD. (Republic of Korea) was used for EBI. The electron beam energy was fixed at 2.5 MeV, and irradiation was performed under ambient temperature and pressure conditions.

To achieve the desired dose, each sample in the zipper bag was irradiated multiple times with 25 kGy per cycle. (Dosage per cycle: 5 kGy, 2.5 MeV, 3.9 mA, conveyor belt speed: 10 m/min, cooling for 5 minutes per 50 kGy)

To prevent thermal degradation of BC, the sample was cooled at room temperature for 5 minutes after each 50 kGy irradiation before the next cycle.

Water-soluble substances such as oligomers generated by degradation of BC through EBI were separated from the irradiated BC using a high-speed centrifuge (LaboGene 223R, Gyrozen). The centrifugation was conducted at 10,000 rpm for 15 minutes at 4° C. After centrifugation, the supernatant was discarded, and the precipitated BC sample was stored in zipper bags at 3° C.

The total weight (g) and concentration of the separated supernatant were measured to calculate the amount of solids released from BC due to EBI, which was used to determine the water-insoluble yield.

The EBI-treated samples were labeled as BC-E050, where “E” denotes EBI and the following number indicates the irradiation dose in kGy.

### 2-3. TEMPO-Oxidized BC

To impart a negatively charged surface to the BC fibers, TEMPO oxidation was conducted on the BC. This sample was used as a control group for the electron beam-treated BC.

First, cube-shaped BC was mixed with distilled water to prepare a 0.25 wt % mixture (containing 12.5 g of solid content). Then, TEMPO and NaBr were added to the mixture at concentrations of 0.01 mmol/g and 0.1 mmol/g, respectively. The mixture was stirred at 200 rpm at room temperature for 30 minutes to dissolve the TEMPO and NaBr.

Subsequently, NaClO solution (8% available chlorine) was added to the mixture at 10 mmol/g in three portions at intervals of 3 minutes to initiate the oxidation reaction (Chitbangyoung et al., 2020).

During the oxidation, the pH of the mixture was maintained at 10.5 using 0.5 M NaOH solution for 4 hours.

After the oxidation process, the reaction mixture was washed with distilled water using a centrifuge until the pH remained stable, thereby removing residual additives such as TEMPO and NaBr.

The final sample obtained was referred to as TEMPO-oxidized BC, and labeled as BC-TO.

2-4. High-Pressure Homogenization after Electron Beam Irradiation of BC (FIG. 2)

Before mechanical treatment, the electron beam-irradiated BC (BC-E) and the TEMPO-oxidized BC (BC-TO) were mixed with distilled water to prepare a 0.3 wt % mixture. The mixture was pretreated with a small-scale homogenizer (T 25 digital ultra-turrax, IKA, Germany) at 15,000 rpm for 1 minute to form a slurry.

To induce fiber swelling and facilitate further homogenization at the nano scale, the pH of the 0.3 wt % BC slurry was adjusted to 11 using 0.5 M NaOH. This alkaline BC slurry was then processed using a high-pressure homogenizer (HPH; Mini DeBEE, BEE International, MA, USA) at 15,000 psi for five cycles.

After homogenization, carbon dioxide (C02) gas was bubbled into the resulting BC suspension to adjust the pH to 7-8. To prevent a reduction in yield due to the increased viscosity of the BC suspension after HPH treatment, the sample was diluted twofold and then centrifuged at 10,000 rpm for 15 minutes at 4° C. The supernatant was collected, while the sediment is considered to be non-homogenized fibers to be discarded.

As a result, a uniformly dispersed, transparent aqueous suspension of bacterial cellulose nanofibers (BCNFs) was obtained.

Samples subjected to electron beam irradiation were labeled as BCNF-E, where the number following “E” indicates the irradiation dose. Samples subjected to TEMPO oxidation were labeled as BCNF-TO.

### 2-5. Spray Drying and Redispersion of BCNF Suspension (FIG. 2)

The BCNF-E series (50, 100, 300 kGy) and BCNF-TO were diluted to a concentration of 0.1 wt % and subjected to spray drying to obtain powder samples. A mini spray dryer (Mini Spray Dryer, B-290, BUCHI, Switzerland) was used for this process. Specifically, 600 mL of 0.1 wt % BCNF suspension was spray-dried under the following conditions: drying temperature of 103-105° C., feed rate of 10 mL/min, pump speed of 26%, aspirator speed of 96% (36 m³/h), and air flow rate of 600 L/h.

The morphology of the BCNF powder was analyzed using scanning electron microscopy (SEM; MAGNA, Tescan, USA).

To evaluate the redispersibility of all BCNF powder samples, the dried BCNF powders were mixed with distilled water to prepare 0.1 wt % suspensions. The suspensions were then sonicated in an ice bath using a 13 mm probe tip and an ultrasonic processor (VCX 500, Sonics & Materials, Inc., CT, USA) set at 35% amplitude for 5 minutes.

To confirm the uniform dispersion of BCNFs within the suspension, the Tyndall scattering effect was examined using a He—Ne laser (632.8 nm).

Samples prepared through this redispersion process were designated as RE BCNF-E or RE BCNF-TO, respectively.

### 3. Preparation of BCNF Film

### 3-1. Preparation of BCNF Film Via Vacuum Filtration and Hot Pressing (FIG. 3)

Transparent BCNF films were prepared using BCNF suspensions at a concentration of 0.1 wt %. Initially, vacuum filtration was conducted using a funnel in an oven set at 35° C. for 2-6 hours. The resulting BCNF cake formed through vacuum filtration was subjected to hot pressing using a TD-RK Rapid Kothen type Laboratory Sheet Dryer (Regmed, Brazil) at 93° C. under 70 mbar pressure.

The hot pressing process was conducted in two stages. In the first stage, the BCNF cake was sandwiched between poly(tetrafluoroethylene) (PTFE) membrane films (pore size: 0.25 m) on both sides. This assembly was then further sandwiched with wet filter paper and carrier boards, followed by hot pressing for 4 to 6 minutes. The first-stage pressing time was 6 minutes for BCNF-E050 and BCNF-TO, 5 minutes for BCNF-E100, and 4 minutes for BCNF-E300.

In the second stage, the sample was covered on both sides in the order of PTFE membrane film and carrier board, and dried for 1 minute under identical conditions.

Through this process, transparent BCNF films were successfully fabricated. The films prepared from electron beam-irradiated samples were designated as BCNF-E050 film (or similarly labeled according to dose), and those from TEMPO-oxidized samples were designated as BCNF-TO film.

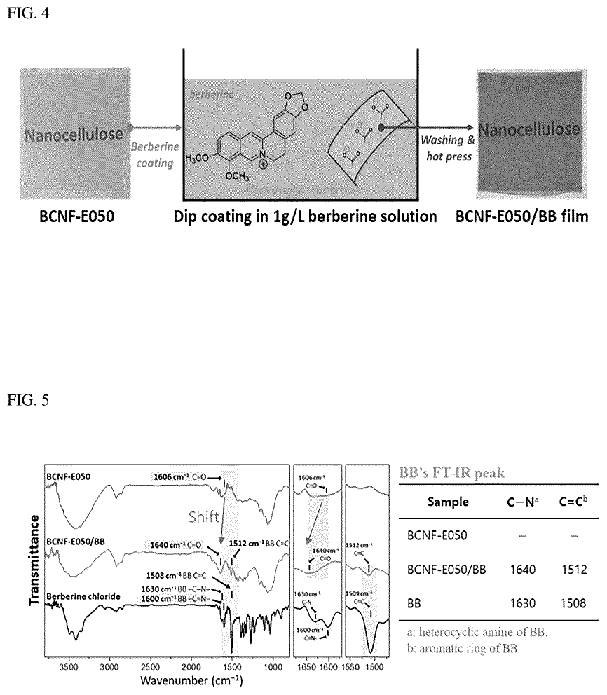

4. Preparation of Functional BCNF Film Via Dip Coating with BB (FIG. 4)

To impart not only water vapor resistance but also ultraviolet blocking, antibacterial, and antioxidant effects to the prepared film, berberine chloride form (BB), a polyphenolic compound, was reacted with the BCNF film. Among the BCNF films, the BCNF-E050 film, which is fabricated under the condition of 50 kGy electron beam irradiation, exhibited the highest mechanical strength and was thus selected for BB treatment.

First, a BB aqueous solution was prepared by mixing BB powder with distilled water to obtain a concentration of 1 g/L, with a total volume of 150 mL. The BCNF-E050 film was immersed in the 0.1 wt % BB solution at room temperature for 24 hours.

After immersion, the film was subjected to vacuum filtration at room temperature for 1 minute to remove residual BB solution from the surface.

It was then washed with distilled water for 1 minute to eliminate unreacted BB. Subsequently, hot pressing was performed at 93° C. under 70 mbar for 2 minutes to yield the final BB-coated film, referred to as BCNF-E050/BB film.

### 5. Characterization

5-1. BC after Electron Beam Irradiation
a. Surface

BC samples treated with electron beam irradiation (BC-E) and those subjected to TEMPO oxidation (BC-TO) were frozen in liquid nitrogen and subsequently freeze-dried for 3 days using a tabletop freeze dryer (Table Top Freeze Dryer, IlShinBioBase, Korea).

After freeze-drying, scanning electron microscopy (SEM, MAGNA, Tescan, USA) was performed to compare the surface morphology of untreated BC with that of BC subjected to various treatments. This analysis aimed to identify physical changes in the BC structure induced by electron beam irradiation or TEMPO oxidation.

b. Degree of Polymerization and Molecular Weight

Freeze-dried BC (50 mg) was placed in a 125 mL Erlenmeyer flask and mixed with 25 mL of distilled water, followed by the addition of 25 mL of 1 M CED (cupriethylenediamine) solution. The mixture was stirred at 400 rpm for 30 minutes at room temperature to dissolve the BC in the CED solution.

After dissolution, the mixture was filtered using a PTFE membrane filter. The intrinsic viscosity [η] of BC was measured using a Cannon-Fenske capillary viscometer, and the degree of polymerization (DPᵥ) was calculated with reference to TABLE 1 of ASTM D4243-99. The molecular weight (M_{η}) was then calculated using the following equation, based on the determined DPᵥ value (ASTM D4243-99, 1996). Here, the molecular weight of one BC repeating unit was assumed to be 162.

Molecular weight (M_{η})=Degree of polymerization (DP_{V})×Molecular weight of BC unit

c. Structure

To analyze the structural characteristics of BC-E and BC-TO, Fourier Transform Infrared Spectroscopy (FT-IR) was performed in the range of 4000-400 cm⁻¹. The FT-IR measurements were carried out using an ALPHA-P Infrared Spectrometer (Bruker, USA).

For FT-IR analysis, the freeze-dried samples were ground into powder in a mortar after being mixed with potassium bromide (KBr) at a weight ratio of 1:9. The resulting powder mixture was then placed into a mold and pressed at 50 mbar for 2 minutes to form a film, which was subsequently used for FT-IR measurement.

d. Carboxyl Group Content

To quantitatively evaluate the extent of oxidation of BC induced by electron beam irradiation and TEMPO oxidation, the carboxyl group content was measured using a titration method. A high-end titrator (888 Titrando, Metrohm AG, Switzerland) was employed for this analysis.

Specifically, 0.1 g of freeze-dried BC under each condition was added to 70 mL of distilled water and stirred at room temperature using a magnetic stir bar for approximately two days until the sample fully swelled.

Subsequently, 0.1 M hydrochloric acid (HCl) was added to the mixture to lower the pH below 3.0. Then, 0.04 M sodium hydroxide (NaOH) solution was titrated into the mixture at a rate of 0.2 mL/min until the pH reached 11. The carboxyl group content was determined based on the titration range recorded by the instrument.

e. Water-Insoluble Yield

To evaluate the yield of BC obtained after electron beam treatment or TEMPO oxidation, the water-insoluble yield was measured.

In the case of electron beam-treated BC, the sample was subjected to centrifugation at 10,000 rpm and 4° C. After centrifugation, the amount of supernatant was measured, and its concentration was determined to calculate the amount of solids (Wr) eluted from BC due to the electron beam treatment. This value was subtracted from the initial amount of solid (W0) content used for the treatment to calculate the water-insoluble yield using Equations (1) and (2) below. Here, Wr refers to the amount (g) of solid content released from BC due to the electron beam treatment, and W0 refers to the amount (g) of solid content initially used for the electron beam treatment.

$$Wr = Amount of supernatant after centrifugation ( g ) \times Concentration of supernatant ( \% ) / 100 \qquad ( Equation 1 )$$

$$Water - insoluble yield ( \% ) = ( W 0 - Wr ) / W 0 \times 100 \qquad ( Equation 2 )$$

In the case of TEMPO-oxidized BC, the sample was washed using distilled water via centrifugation until the pH reached 7-8. The amount of solid lost during the washing process was used to calculate the water-insoluble yield using Equations (1) and (2).

5-2. BCNF after HPH Treatment
a. Morphology of BCNF

The BCNF suspension obtained after HPH treatment was diluted to 0.005 wt % with water and applied onto a carbon-coated copper grid (CF 200-Cu, EMS). The sample was then stained using a 0.2 wt % uranyl acetate aqueous solution. Approximately 0.04 mL of the BCNF suspension and 0.05 mL of the staining solution were applied to the carbon-coated copper grid. The stained samples were dried at room temperature in the dark for 3 days.

Subsequently, the length and thickness of the BCNF were measured using a JEM-2100F transmission electron microscope (TEM). More than 100 individual BCNFs were analyzed using TEM to calculate the average values and distributions of their lengths and thicknesses.

b. Surface Potential

To investigate the reason for the dispersion of BCNF fibers in the BCNF suspension, the surface potential of the suspension was measured. The ζ-potential was measured using a Laser Doppler Velocimeter (LDV) (Zetasizer Nano ZS series, Malvern Instruments Ltd, UK) under pH 7-7.5 conditions with a BCNF suspension concentration of 0.1 wt^{%}.

c. Disintegration Yield♀├ Total Yield
c. Disintegration Yield and Total Yield

The disintegration yield was calculated by measuring the concentration of the BCNF suspension after HPH treatment and the concentration of the supernatant obtained by centrifugation of the HPH-treated BCNF suspension (Equation 3).

Here, Cb refers to the concentration of the BCNF suspension after HPH treatment without centrifugation, and Ca refers to the concentration of the supernatant BCNF suspension after centrifugation.

$$Disintegration yield ( \% ) = Cb ( \% ) \times Ca ( \% ) / 100 \qquad ( Equation 3 )$$

The total yield was obtained by multiplying the water-insoluble yield by the disintegration yield (Equation 4).

$$Total yield ( \% ) = water - insoluble yield ( \% ) \times disintegration yield ( \% ) / 100 \qquad ( Equation 4 )$$

### 5-3. Thermal Stability

To evaluate the thermal stability of BC, BCNF, and BCNF films treated with electron beam irradiation or TEMPO oxidation, thermogravimetric analysis (TGA) was performed using a TA Q500 thermogravimetric analyzer. Prior to analysis, both BC and BCNF suspensions were freeze-dried.

Approximately 5 mg of each sample was heated to 600° C. at a heating rate of 10° C./min under a nitrogen atmosphere.

### 5-4. Crystallinity Index

To evaluate the crystallinity of BC, BCNF, and BCNF films subjected to electron beam irradiation or TEMPO oxidation, X-ray diffraction (XRD) analysis was conducted using a Rigaku Ultima IV X-ray diffractometer with Cu radiation (λ=0.154 nm).

BC and BCNF suspensions were freeze-dried prior to analysis. XRD measurements were performed in the 2θ range of 5-40° at a scanning rate of 0.03°/sec under 40 kV and 40 mA conditions. The crystallinity index (CrI, %) was calculated using the Segal equation shown below:

$$C r I ( \% ) = [ ( {I}_{002} - {I}_{a m} ) ] / {I}_{002}$$

Here, I₀₀₂ is the intensity of the main crystalline peak of cellulose, of which fraction is corresponding to the 20 range of 22-23°. In addition, Iₛₘ is the intensity of the amorphous region, of which fraction is corresponding to the 20 range of 18-19°.

### 5-5. Light Transmittance

To evaluate the transparency of the prepared BCNF suspension, redispersed BCNF suspension, and BCNF films, light transmittance was measured using a UV-Vis spectrometer (UV01659PC, Shimadzu, Japan).

The BCNF suspension and the redispersed BCNF suspension were prepared at a concentration of 0.1 wt %, and their transmittance was measured in the wavelength range of 400-700 nm. For BCNF films, the film was placed in the spectrometer, and the transmittance in the wavelength range of 400-700 nm was measured.

In the case of the BCNF films, measurements were taken from four different areas of the film, and the average value was calculated.

5-6. BCNF film

### Density, Porosity, and Roughness

BCNF films were cut into 1×1 cm squares, and their weights were measured. The thickness of the films was measured using a vernier caliper. The density of the film was then calculated using Equation (5), and the porosity of the BCNF film was calculated using Equation (6) by dividing the obtained density by the density of pure cellulose, which is 1.5 g/cm³.

$$Film density ( g / {cm}^{3} ) = Weight of BCNF film ( g ) / Volume of film ( {cm}^{3} ) \qquad ( Equation 5 )$$

Film porosity (%)=Film density (g/cm³)/Cellulose density (g/cm³) (Equation 6)

In addition, to confirm whether the roughness of the BCNF film decreased after impregnation with BB aqueous solution, the roughness of the BCNF film before and after BB treatment was measured and compared using atomic force microscopy (AFM) in tapping mode. The AFM instrument used was Bruker (Dimension Icon).

b. Mechanical Properties

To evaluate the mechanical properties of the fabricated films, tensile strength tests were conducted. The instrument used for analysis was the MultiTest-I (Mecmesin, UK). The films were cut into strips with a width of 3 mm and a length of 3 cm for the tensile test. The measurement conditions were a gauge length of 10 mm and a tensile speed of 1 mm/min. A 250 N load cell was used for the measurements. Each sample was tested more than 10 times, and the average value was calculated.

c. Oxygen Permeability

The oxygen permeability of the BCNF film was analyzed by the Korea Institute of Industrial Technology (KITECH). A film sample with an area of 50 cm² was prepared, and the oxygen permeability was measured using an OX-TRAN 2/22 system (MOCON, USA) in accordance with ASTM D 3985. The test was conducted at a temperature of 23° C., and the measurement range was set to 0.0005-200 cc m⁻² day

d. Water Vapor Transmission Rate

The water vapor transmission rate was analyzed according to ASTM E 96. A temperature and humidity chamber (Temperature & Humidity Chamber Tabletop type, JEIOTECH, Korea) and a vapor permeability cup (EZ-Cup Vapometer Permeability Cup, Thwing Albert, USA) were used for the measurement. The procedure was as follows: First, 10 g of calcium chloride (CaCl₂)) was dried overnight at 105° C. The CaCl₂) was then placed in the vapor cup, and the film was placed on top of the cup. The weight change was measured over 7 days under conditions of 50% relative humidity at 23° C.

### 5-7. Functional Properties of BB Dip-Coated BCNF Film

### Water Resistance

To confirm whether the BCNF-E050 film impregnated with BB solution acquired functional properties such as water resistance, UV blocking, antibacterial activity, and antioxidant activity, analyses were performed. To evaluate the water resistance of the BCNF-E050 film, the water contact angle was measured. The film was cut into 1×3 cm pieces, placed on a drop shape analyzer (DSA 100S, KRUSS, Germany), and the change in contact angle over time was measured.

b. Ultra-Violet (UV) Blocking Performance

To evaluate the UV blocking performance and transparency of the films, the transmittance of the BCNF-E050 film and the BCNF-E050/BB film was measured using a spectrophotometer in the UV range (200-400 nm) and visible light range (400-700 nm). To visually assess whether UV blocking ability was imparted to the BCNF-E050 film through BB impregnation, an experiment was conducted using a UV detection card (Gurung Science Co., Korea) and artificial skin (Franz Cell Membrane, APURES, Korea). The UV detection card test was carried out as follows: the BCNF-E050 film and the BCNF-E050/BB film were each placed on top of a UV detection card, and a UV lamp (ROBUST UV 12LED, ROBUST, Korea) was applied to observe the color change on the card.

In the experiment using artificial skin, 10 g of distilled water was placed in a glass dish, and the artificial skin was immersed in it. The artificial skin was then covered with the BCNF-E050 film and the BCNF-E050/BB film, followed by irradiation with UV light across the full UV spectrum (200-400 nm) using a UV irradiation device (Spot Light Source LC8 L9588, HAMAMATSU Photonics, Japan). The UV exposure was conducted for 3 hours per day over two days at room temperature in a dark environment. As controls, one group of artificial skin was not exposed to UV, and another was exposed to UV without any film covering. After UV irradiation, the artificial skins were immersed in a 10-fold diluted aqueous solution of 36.5-38.0% formaldehyde, and hematoxylin and eosin (H&E) staining and slide preparation were commissioned to Biolead Co., Ltd. The cross-sections of the artificial skin were then observed using an optical microscope (BX 51, Olympus, Japan).

c. Antibacterial Property

To evaluate the antibacterial properties of the BCNF-E050 film and the BCNF-E050/BB film, analysis was commissioned to the Korea Analysis Test Researcher (KATR). The antibacterial performance was assessed using ASTM E2149 (Shake Flask Method), employing Staphylococcus aureus (S. aureus ATCC 6538), a type of Gram-positive bacteria, and Escherichia coli (E. coli ATCC 8739), a type of Gram-negative bacteria. The bacterial reduction rate was calculated using the following equation:

$$Bacterial reduction rate ( \% ) = \{ ( {C}_{t} - {S}_{t} ) / {C}_{t} ) \} \times 100$$

d. Applicability Analysis

To evaluate whether the final fabricated film can be used as a packaging material, such as for food packaging, apples were directly packaged with the prepared films, and changes in the appearance of the apples over time were observed. First, apples were placed in glass jars, and the jar openings were covered with either the BCNF-E050 film or the BCNF-E050/BB film, then sealed with adhesive. As control conditions, glass jars sealed with low-density polyethylene (LDPE), which is widely used for food packaging, and jars without any film covering were also prepared. The jars containing apples were placed in a temperature and humidity chamber, and the weight of the apples was measured over time to calculate the weight loss rate. The weight loss rate was calculated using the following equation, where W₀ is the initial weight of the apple, and WA is the weight of the apple after a certain period of time:

$$Weight loss rate ( \% ) = ( {W}_{0} - {W}_{A} ) / {W}_{0} * 100$$

### 6. Results

6-1. Electron Beam-Treated BC after Purification

The present disclosure provides a method for producing BCNFs using a simple and efficient process while minimizing the use of chemicals (FIG. 2).

Nata de coco contains substances such as bacterial residues and components of the culture medium, including monosaccharides and citric acid, which must be removed through a purification process. Therefore, the nata de coco was purified using 0.1 M NaOH and distilled water to obtain pure BC, which was then used in the experiments.

The BC obtained through the purification process had a cube shape with high water content and was placed in a zipper bag for EBI treatment. To determine whether the surface of the BC underwent physical changes due to EBI, the surfaces of non-irradiated BC (BC-E000), electron beam-irradiated BC (BC-E series), and TEMPO-oxidized BC (BC-TO) were examined using SEM. The results showed that the surfaces of BC-E000, the BC-E series, and BC-TO were similar, indicating that neither electron beam irradiation nor TEMPO oxidation caused physical changes to the BC.

To evaluate the extent of BC degradation caused by EBI, freeze-dried BC was dissolved in a CED aqueous solution, and its viscosity was measured to calculate the degree of polymerization (DP) and molecular weight (M_{w}). The analysis showed that electron beam irradiation cleaved the ester rings of BC, resulting in degradation, thereby lowering the DP and M_{w}. In the case of the sample irradiated with 50 kGy (BC-E050), the DP was higher by 81 and the M_{w} was approximately 13 kg/mol greater than that of the control sample, BC-TO. This is because TEMPO oxidation involves the use of a strong oxidizing agent, NaClO, which oxidizes the hydroxyl groups of BC and breaks the BC chains more extensively than electron beam irradiation at 50 kGy, leading to lower DP and M_{W} in BC-TO compared to BC-E050.

To investigate the structural changes in BC induced by EBI, FT-IR analysis was performed. Anew peak appeared at 1727 cm⁻¹ in both electron beam-irradiated BC and TEMPO-oxidized BC, which is attributed to the C═O stretching vibration of carboxyl groups in their acidic form. This peak indicates that carboxyl groups were introduced into the BC structure by both electron beam irradiation and TEMPO oxidation. Furthermore, the intensity of the peak at 1727 cm⁻¹ increased with higher electron beam doses, suggesting that the introduction of carboxyl groups is proportional to the irradiation dose.

EBI-treated BC is more effective than EBI-treated dried wood pulp, which can be attributed to the fact that BC is a bottom-up synthesized cellulose that, unlike wood-based materials, does not contain impurities such as hemicellulose and lignin that could interfere with the effects of electron beam irradiation. Additionally, the BC used in this study contained a large amount of water, and the presence of moisture both inside and outside the BC further enhanced the effects of the electron beam.

TABLE 1

| | | Water- | | | | | | | |
|---|---|---|---|---|---|---|---|---|---|
| | EBI | insoluble | Carboxyl | | | | | | |
| | dosage^{b} | yield^{c} | content^{b} | [η]^{d} | | M_{w} [symbol] | CrI [symbol] | T_{d, onset} [symbol] | T_{d, max}^{k} |
| Sample | (kGy) | (%) | (mmol · g⁻¹) | (ml · g⁻¹) | DP [symbol] | (kg · mol⁻¹) | (%) | (° C.) | (° C.) |
| BCNF-E050 | 50 | 98 | 0.12 ± 0.01 | 2400 | 323 | 55 | 91 | 267 | 366 |
| BCNF-E100 | 100 | 93 | 0.20 ± 0.01 | 1240 | 166 | 27 | 92 | 255 | 361 |
| BCNF-E300 | 300 | 81 | 0.30 ± 0.03 | 490 | 65 | 11 | 91 | 242 | 354 |
| BC-TO^{a} | TEMPO | 53 | 0.72 ± 0.02 | 1880 | 251 | 41 | 91 | 234 | 349, 309 |
| | system | | | | | | | | |

[symbol]

indicates data missing or illegible when filed

a For detailed procedures, refer to the Experimental section.

b All cube-shaped bacterial cellulose samples were disintegrated using EBI at doses ranging from 50 to 300 kGy, and TEMPO oxidation was also performed for comparison.

c The disintegrated BC samples were thoroughly washed through a combination of centrifugation and precipitation to remove water-soluble fractions, and stored in a cubic form. The water-insoluble yield was determined by comparing the dry weights before and after EBI or TEMPO oxidation.

d The intrinsic viscosity [η] was calculated by applying the Martin equation to the specific viscosity [ηs] and concentration of the BC samples. The specific viscosity [ηs] was determined using the following equation:

$$[ η s ] = ( {T}_{s} - {T}_{0} ) / {T}_{0} ,$$

where Tₛ is the average efflux time of the solvent (a 0.5 M cupriethylenediamine (CED) solution in water (H₂O)), and T₀ is the average efflux time of the solution containing the BC sample.

ASTM D4243-99. Standard Test Method for Measurement of Average Viscosity-Based Degree of Polymerization of New and Aged Electrical Papers and Boards. ASTM Annual Book of Standards; American Society for Testing and Materials.

e The average viscosity-based degree of polymerization (DPᵥ) was calculated using the following equation:

$$D {P}_{v} α = [ η ] / K ( α = 1 , K = 7.5 \times {10}^{- 3} ) . [ ASTM D 4243 - 99 , 1999. ]$$

f The weight-average molecular weight (M_{W}) of the disintegrated BC, based on CED measurements, was calculated using the equation:

$$D {P}_{v} = {M}_{w} / 162 ( where 162 g / mol is the molecular weight of the anhydroglucose unit ) .$$

h The carboxylate content (mmol/g) of the BC samples was determined by conductivity titration.

i The crystallinity index (CrI) was calculated using the Segal equation:

$$C rI ( \% ) = [ ( {I}_{002} - {I}_{a m} ) / {I}_{002} ] \times 100 ,$$

where I₀₀₂ is the maximum peak intensity at 20=22-23°, corresponding to the main crystalline plane of cellulose Ia, and lam is the peak intensity of the amorphous fraction at 20=18-19°.

j The onset decomposition temperature (T_{d oneset}), as determined by thermogravimetric analysis (TGA), refers to the temperature at which a 5% weight loss occurred under a nitrogen atmosphere at a heating rate of 10° C./min.

k The maximum decomposition temperature (T_{a,max}) was determined from the derivative thermogravimetry (DTG) curve.

### 6-2. BCNFs Prepared by Electron Beam Irradiation and High-Pressure Homogenization

BC treated with EBI was processed into a slurry form using a small-scale homogenizer such as Ultra-Turrax, and then subjected to high-pressure homogenization (HPH) under alkaline conditions to produce BCNFs that were transparently dispersed in water. In the case of BCNF suspensions prepared without EBI treatment, aggregation of nanofibers due to hydrogen bonding was observed after one month. However, for BCNF suspensions prepared via EBI or TEMPO oxidation, the BCNFs remained well-dispersed in water over time. This is because carboxyl groups were introduced onto the surface of BCNFs through EBI or TEMPO oxidation, resulting in a surface charge of over 30 mV, which caused electrostatic repulsion between the nanofibers, preventing aggregation over time. Both BCNF-E and BCNF-TO suspensions exhibited high transparency, with transmittance reaching 86% at a wavelength of 700 nm.

To determine the length and diameter of the prepared BCNFs, more than 100 individual BCNFs were measured using transmission electron microscopy (TEM), and their distribution profiles were analyzed. The TEM results showed that as the electron beam irradiation increased, both the length and diameter of the BCNFs decreased, but their size distribution became more uniform. In particular, BCNF-E050 exhibited a length exceeding 7 m, which is 0.3 m longer than that of BCNF-TO, whose average length was 6.7 μm.

### 6-3. Yield, Thermal Stability, and Crystallinity of BC and BCNF

In the process of preparing BCNF suspensions using electron beam irradiation and high-pressure homogenization (HPH), the yield at each step was evaluated. First, the water-insoluble yield, which reflects the yield after electron beam irradiation, decreased as the irradiation dose increased. This is likely due to increased degradation of BC with stronger irradiation, resulting in the formation of more water-soluble oligomers and other compounds that were subsequently removed. However, all electron beam-treated samples (BC-E) exhibited higher water-insoluble yield than the TEMPO-oxidized sample (BC-TO), presumably because the strong oxidizing agent NaClO used in TEMPO oxidation caused extensive BC degradation, and the degraded components were lost during multiple washing steps.

For the disintegration yield after HPH treatment, both BCNF-E and BCNF-TO showed high values exceeding 93%. When combining the water-insoluble yield and disintegration yield to calculate the total yield, all electron beam-treated samples had a total yield of over 79%, whereas the TEMPO-oxidized sample showed a relatively lower yield of approximately 51%.

To investigate whether crystallinity and thermal stability of BC change during the EBI and HPH treatment processes, XRD and TGA analyses were conducted on samples prepared under each condition (BC-E series, BC-TO, BCNF-E series, and BCNF-TO). First, when comparing the crystallinity of the untreated sample (BC-E000) with the BC-E series and BC-TO, almost no change in crystallinity was observed. Even after HPH treatment, the crystallinity decreased by less than 5%.

In terms of thermal stability, it was confirmed that the degradation temperature of BC decreased as the electron beam irradiation dose increased. Moreover, when the BC-E series and BC-TO samples were subjected to HPH treatment, the thermal stability decreased by more than 48° C. In the DTG graphs of both the electron beam-treated samples (BC-E series, BC-TO) and the fully processed samples (BCNF-E series, BCNF-TO), a shoulder peak appeared in the specific temperature range of 193-249° C., which is presumed to be due to the carboxyl groups introduced into the BC.

TABLE 2

| | Disinte- | | | | | | | | |
|---|---|---|---|---|---|---|---|---|---|
| BC | gration | Overall | | | Trans- | | | | |
| nano- | yield^{c} | yield^{d} | Length^{e} | Width [symbol] | mittance^{f} | Charge^{g} | CrI^{h} | T_{d, onset}ⁱ | T_{d, max} [symbol] |
| fibers^{b} | (%) | (%) | (μm) | (nm) | (%) | (mV) | (%) | (° C.) | (° C.) |
| BCNF-E050 | 85 | 83 | ≥7.0 | 28 ± 16 | 86 | −32.1 ± 3.7 | 88 | 214 | 234, 318 |
| BCNF-E100 | 94 | 87 | 5.5 ± 2.4 | 20 ± 10 | 89 | −37.4 ± 1.0 | 88 | 309 | 231, 317 |
| BCNF-E300 | 97 | 78 | 3.0 ± 1.5 | 18 ± 10 | 90 | −41.8 ± 3.0 | 89 | 196 | 225, 303 |
| BCNF-TO | 96 | 51 | ≥6.7 | 19 ± 1 | 88 | −44.6 ± 0.8 | 86 | 207 | 193, 291 |

[symbol]

indicates data missing or illegible when filed

a Refer to the experimental section for detailed information.

b All carboxylated BCNFs were obtained via high-pressure homogenization of dissociated bacterial cellulose as described in Table 1.

c Disintegration yield was determined based on the oven-dried mass of BCNF after high-pressure homogenization and subsequent centrifugation.

d Overall yield was calculated from the water-insoluble yield and disintegration yield.

e Length and width of all BCNFs were evaluated by transmission electron microscopy (TEM), with at least 100 measurements taken to determine average values and standard deviations.

f Transmittance of BCNF suspensions (0.1% w/w) was measured in the 400˜700 nm wavelength range using a UV-Vis spectrophotometer (UV01659PC, Shimadzu, Japan).

g Surface charge (zeta potential) of BCNFs was measured using laser Doppler velocimetry (Zetasizer Nano ZS series, Malvern Instruments Ltd., UK) in 0.1% (w/w) suspensions.

h Crystallinity index (CrI) was calculated based on the Segal equation.

$$CrI ( \% ) = [ ( {I}_{002} - {I}_{a m} ) / {I}_{002} ] \times 100 ,$$

where I₀₀₂ is the maximum intensity of the diffraction from the crystalline plane (002) of the bacterial cellulose sample at 20=22-23° and Iₐₘ is the minimum intensity at 0=18-19°.

i Onset decomposition temperature (T_{d onset}) indicates the temperature at which 5% weight loss occurred during thermogravimetric analysis (TGA) under N₂ atmosphere at a heating rate of 10° C./min.

j Maximum decomposition temperature (T_{d max}) was determined by derivative thermogravimetric analysis (DTG).

6-4. BCNF Suspension and Redispersion after Spray Drying

To enable the commercial use of BCNFs treated with electron beam irradiation (EBI), storing and transporting them in powder form is more efficient and cost-effective. Therefore, BCNF suspensions prepared via EBI and high-pressure homogenization (HPH) were spray-dried into powders, and a redispersion test was conducted to evaluate whether they could be redispersed in water. First, scanning electron microscopy (SEM) analysis of the spray-dried BCNF powders revealed that the long fibers were dried in a helical twisted form due to the spray drying process. Then, the spray-dried BCNF samples were mixed with water to prepare 0.1 wt % mixtures, followed by ultrasonication for redispersion. As a result, all samples (RE-BCNF-E series and RE-BCNF-TO) were transparently dispersed in water with a transmittance of over 86%. This ability of the RE-BCNF-E series and RE-BCNF-TO to redisperse in water is attributed to the surface charge of all BCNF samples being greater than +30 mV, as shown in Table 3.

TABLE 3

| Redispersed | Redispersion | Length^{d} | Width^{d} | Transmittance [symbol] | Charge [symbol] |
|---|---|---|---|---|---|
| BCNFs [symbol] | yield [symbol] (%) | (μm) | (nm) | (%) | (mV) |
| RE-BCNF-E050 | 95 | 6.0 ± 2.3 | 28 ± 16 | 87 | −36.2 ± 1.0 |
| RE-BCNF-E100 | 93 | 4.4 ± 2.0 | 20 ± 10 | 86 | −35.4 ± 1.0 |
| RE-BCNF-E300 | 93 | 2.4 ± 0.8 | 18 ± 10 | 89 | −36.7 ± 0.8 |
| RE-BCNF-TO [symbol] | 94 | 4.1 ± 2.1 | 19 ± 1 | 90 | −42.0 ± 1.7 |

[symbol]

indicates data missing or illegible when filed

a Refer to the experimental section for detailed information.

b All redispersed samples were prepared by spray-drying the BCNFs listed in Table 2, mixing the resulting powders with water at a concentration of 0.1 wt %, and then ultrasonically treating the mixture until the BCNF powders were completely redispersed in water.

c Redispersion yield was measured based on the oven-dried weight of the redispersed BCNFs (RE-BCNFs) obtained after centrifugation.

d The length and width of all RE-BCNFs were evaluated using transmission electron microscopy (TEM). At least 100 measurements were taken to determine the average dimension and standard deviation.

e Transmittance values of all RE-BCNF suspensions (0.1% w/w) were measured in the wavelength range of 400-700 nm using a UV-Vis spectrophotometer (UV01659PC, Shimadzu, Japan).

f The surface charge of all RE-BCNFs was determined from the zeta (( ) potential values of RE-BCNF suspensions (0.1% w/w) using particle electrophoresis via laser Doppler velocimetry (Zetasizer Nano ZS series, Malvern Instruments Ltd., UK).

### 6-5. Fabrication of BCNF Films Using Vacuum Filtration and Hot Pressing

BCNF films (BCNF-E series, BCNF-TO) were fabricated using vacuum filtration and hot pressing of BCNF suspensions. When the prepared BCNF films were placed over an A4 sheet with printed text, the text underneath was visible, indirectly indicating the transparency of the films. When the light transmittance of each BCNF film was measured, all showed transparency with transmittance values exceeding 60% (Table 4).

When the BCNF-based films under all conditions were bent and held with tweezers, it was confirmed that all films flexed without breaking and maintained a stable shape. The density and porosity of the BCNF-based films were measured, and the results showed that all films had a density of approximately 1.2-1.4 g/cm³ regardless of the degree of electron beam irradiation. However, as the EBI level increased, the porosity decreased (Table 4).

In the case of EBI-treated BCNF films, the porosity was reduced from 23% to as low as 8%, and the BCNF-TO film showed a porosity of 17%. The decrease in porosity with increasing EBI level is attributed to the shortening of BCNF length due to EBI, leading to a more compact structure between fibers. Even in film form, the BCNFs retained their crystallinity, and the thermal stability was higher in the film form than in the suspension form (Table 4). This is because, while the thermogravimetric analysis (TGA) was conducted after freeze-drying of the BCNF suspension into an aerogel form, the BCNF film consisted of densely packed BCNFs, resulting in higher measured thermal stability.

To quantitatively evaluate the mechanical properties of the BCNF-based films, tensile tests were conducted. According to the tensile test results, the BCNF-E series films exhibited a stress of approximately 100-187 MPa and a strain of 1.3-3.5%, with toughness ranging from 688-6067 kJ/m³. The BCNF film prepared via TEMPO oxidation showed a stress and strain of 158 MPa and 2.7%, respectively, and a toughness of 3793 kJ/m³, indicating lower mechanical properties compared to the BCNF-E050 film (Table 5). This is likely because the BC irradiated with 50 kGy had a higher DP value than BC-TO, and the BCNF-E050 fibers were about 300 nm longer than the BCNF-TO fibers, leading to the superior mechanical properties of the BCNF-E050 film (Table 1, Table 2).

TABLE 4

| | Thick- | Trans- | | | | | |
|---|---|---|---|---|---|---|---|
| BCNF | ness^{b} | mittance | CrI | Density^{c} | Porosity^{d} | T_{d, onset} | T_{d, max} |
| based film | (μm) | (%) | (%) | (g · cm⁻³) | (%) | (° C.) | (° C.) |
| BCNF-E050 | 56 ± 2 | 60 | 89 | 1.2 ± 0.1 | 23.1 ± 45 | 269 | 274, 351 |
| BCNF-E100 | 53 ± 3 | 81 | 88 | 1.2 ± 0.1 | 19.6 ± 4.4 | 251 | 261, 348 |
| BCNF-E300 | 53 ± 5 | 80 | 92 | 1.4 ± 0.1 | 7.8 ± 5.7 | 225 | 221, 345 |
| BCNF-TO^{a} | 52 ± 7 | 83 | 85 | 1.2 ± 0.1 | 17.1 ± 3.9 | 234 | 255, 326 |

a See Experimental Section for details.

b The thickness of all BCNF films was measured using a vernier caliper.

c The density (g/cm³) of the films was calculated by dividing the weight (g) of the BCNF film by its volume (cm³). The volume of each BCNF film was determined by multiplying its length (cm), width (cm), and thickness (cm).

d The porosity (%) of the BCNF films was calculated by dividing the density (g/cm³) of each BCNF film by the density of pure cellulose (g/cm³). The density of pure cellulose was assumed to be 1.5 g/cm³ for this calculation.

TABLE 5

| | | | Young's | |
|---|---|---|---|---|
| | Stress [symbol] | Strain at | modulus [symbol] | Toughness [symbol] |
| Sample | (MPa) | break [symbol] (%) | (GPa) | (kJ/m²) |
| BCNF-E050 | 187.1 ± 22.0 | 3.5 ± 0.8 | 8.7 ± 1.4 | 6067 |
| BCNF-E100 | 131.6 ± 19.8 | 1.8 ± 0.5 | 8.3 ± 1.0 | 1217 |
| BCNF-E300 | 100.3 ± 5.3 | 1.3 ± 0.3 | 7.5 ± 1.2 | 688 |
| BCNF-TO | 158.4 ± 22.2 | 2.7 ± 0.6 | 9.5 ± 2.1 | 3793 |

[symbol]

indicates data missing or illegible when filed

a Mechanical properties were evaluated using tensile specimens in accordance with the tensile test standard ASTM D1708.

### 6-6. BB Dip-Coated BCNF Film

BCNF-based films have limited applications due to their low moisture resistance. To overcome this limitation, additives were incorporated into the BCNF-based film. By using BB, the film was endowed not only with moisture resistance but also with UV-blocking, antibacterial, and antioxidant properties, thereby expanding its potential applications.

To combine the BCNF-E050 film with BB, a dip-coating method was employed. The BCNF-E050 film was immersed in a 1 g/L aqueous BB solution for 24 hours, followed by washing with distilled water. The film was then dried using a hot press for 1 minute to complete the BCNF-E050/BB film. When the BCNF-E050 film was impregnated in the BB solution, its color changed from light white to yellow, indirectly indicating that BB was successfully attached to the film (FIG. 4).

To determine whether the carboxyl groups on the BCNF-E050 film electrostatically interacted with the quaternary ammonium groups of BB as intended, FT-IR analysis was conducted on the BCNF-E050 film, BCNF-E050/BB film, and BB powder. The results showed that a peak appeared at 1606 cm⁻¹ in the BCNF-E050 film due to the salt form of the carboxyl groups. In contrast, this peak shifted to 1640 cm⁻¹ in the BCNF-E050/BB film, confirming that the carboxyl groups of the BCNF-E050 film and the quaternary ammonium salts of BB were electrostatically bound (FIG. 5).

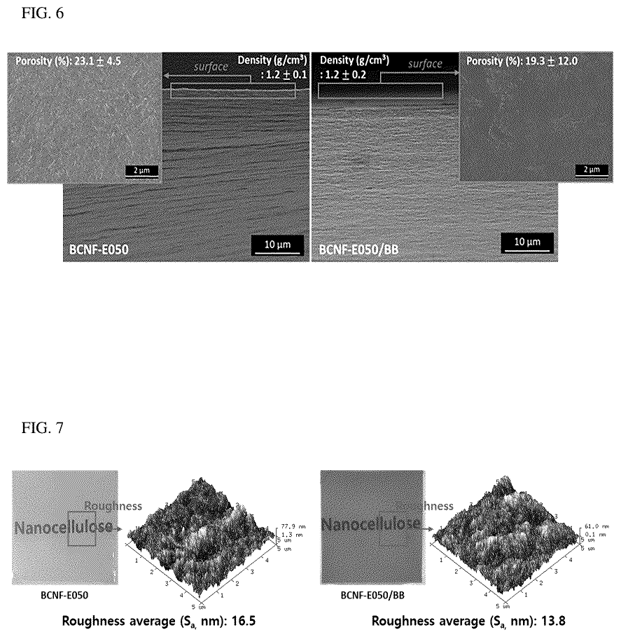

To investigate the physical property changes of the BCNF-E050 film before and after BB impregnation, the surface and cross-section of both the BCNF-E050 film and the BCNF-E050/BB film were analyzed using SEM (FIG. 6). Additionally, the weight of each film was measured to assess changes in film density and porosity (Table 7). Surface roughness under each condition was also examined using AFM (FIG. 7).

As shown in FIG. 6, the surface of the BCNF-E050 film became smoother after BB dip-coating. This indicates that during the BB dip-coating process, the pores of the BCNF-E050 film were likely filled with BB particles, resulting in the observed change. To confirm this, the porosity of the BCNF-E050 film and the BCNF-E050/BB film was measured (Table 7), and it was found that the porosity decreased from 23.1% to 19.3% after BB dip-coating. Additionally, SEM analysis revealed that the surface roughness of the BCNF-E050 film decreased from approximately 16.5 nm to 13.8 nm following BB dip-coating (FIG. 7).

This indicates that BB particles filled the pores of the BCNF-E050 film, resulting in a smoother surface. On the other hand, the density of the BCNF-E050 film remained unchanged after immersion in the BB solution, suggesting that the BB particles were primarily embedded within the BCNF-E050 film (Table 7).

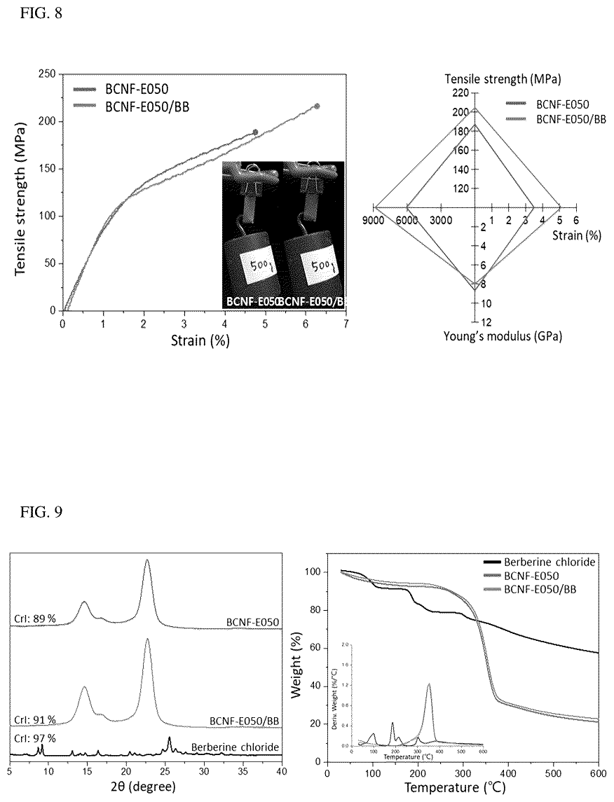

To evaluate the changes in mechanical properties after dip-coating the BCNF film in the BB solution, the BCNF-E050/BB film and BCNF-E050 film were cut into pieces at least 1 cm wide and 3 cm long, and tensile tests were conducted. The tensile test results showed that after immersing the BCNF film in the BB solution, the stress increased from 187.1 MPa to 204.7 MPa and the strain increased from 3.5% to 5.1%. This is because the BB particles filled the pores of the BCNF film, reducing the surface charge of the BCNF due to the presence of BB particles, which in turn allowed greater interactions such as van der Waals forces (Table 6, FIG. 8). Additionally, it was confirmed that the crystallinity and thermal stability of the BCNF-E050 film were maintained even after adding BB (FIG. 9, Table 7).

TABLE 6

| | | | | |
|---|---|---|---|---|
| | | | Young's | |
| | Stress | Strain at | modulus | Toughness |
| Sample | (MPa) | break (%) | (GPa) | (kJ/m²) |

Before dip coating

| | | | | |
|---|---|---|---|---|
| BCNF-E050 | 187.1 ± 22.0 | 3.5 ± 0.8 | 8.7 ± 1.4 | 6067 |

After dip coating

| | | | | |
|---|---|---|---|---|
| BCNF-E050/BB | 204.7 ± 12.6 | 5.1 ± 1.1 | 8.0 ± 1.0 | 8843 |

TABLE 7

| | | | | | | |
|---|---|---|---|---|---|---|
| | Trans- | | | | | |
| | mittance | CrI | T_{d, onset} | T_{d, max} | Density | Porosity |
| Samople | (700 nm, %) | (%) | (° C.) | (° C.) | (g/cm³) | (%) |

Before dip coating

| | | | | | | |
|---|---|---|---|---|---|---|
| BCNF-E050 | 60 | 89 | 269 | 274, 331 | 1.2 ± 0.1 | 23.1 ± 4.5 |

After dip coating

| | | | | | | |
|---|---|---|---|---|---|---|
| BCNF-E050/BB | 56 | 91 | 263 | 353 | 1.2 ± 0.2 | 19.3 ± 12.0 |

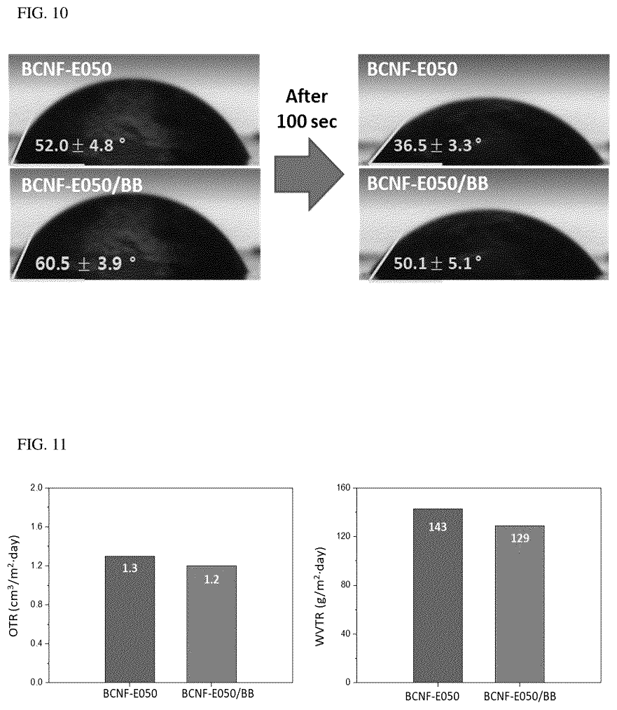

To determine whether the addition of BB imparted water resistance to the BCNF-E050 film, the water contact angle was measured. The contact angle of the BCNF-E050 film was 52.0°, but after BB dip-coating, it increased to 60.5°, showing an approximately 16% increase in the water droplet angle. This indicates that hydrophobicity was imparted to the BCNF-E050 film by BB dip-coating. Additionally, for the BCNF-E050 film, the contact angle was 52° immediately after placing the water droplet, but decreased to 36.5° after 100 seconds, resulting in a reduction of about 16°. However, for the BB-treated BCNF-E050 film, the contact angle decreased only by 10°, from 60.5° to 50.1°. This phenomenon is associated with the increased hydrophobicity of the BCNF-E050 film as a result of BB dip-coating (FIG. 10).

### 6-7. Applications of BB Dip-Coated BCNF Film

To evaluate the potential use of BCNF-based films as packaging materials, their functional properties-such as oxygen and water vapor permeability, UV blocking ability, antibacterial activity, and antioxidant activity-were analyzed. First, measurements of oxygen and water vapor permeability were conducted for both BCNF-E050 film and BB-treated BCNF-E050/BB film. The oxygen permeability of the BCNF-E050 film was 1.3 cm³·m⁻²·day⁻¹, and its water vapor permeability was 143 g·m⁻²·day⁻¹. In contrast, the BCNF-E050/BB film exhibited an oxygen permeability of 1.2 cm³·m²·day¹ and a water vapor permeability of 129 g·m⁻²·day⁻¹. These results indicate that oxygen permeability decreased by 8% and water vapor permeability by 11% upon BB incorporation into the BCNF-E050 film (FIG. 11).

This is likely due to the BB particles filling the pores of the BCNF film and the hydrophobic structure of BB being incorporated into the film, which imparted water resistance to the BCNF-E050 film.

Next, to determine whether UV-blocking properties were imparted by BB dip-coating and to examine any changes in light transmittance of the BCNF-E050 film after BB coating, the transmittance of both the BCNF-E050 film and the BCNF-E050/BB film was measured across the wavelength range of 200-700 nm. At 700 nm, the light transmittance of the BCNF-E050/BB film was found to be nearly the same as that of the original BCNF-E050 film after BB dip-coating, indicating that the overall light transmittance was maintained [FIG. 12(a)].

This result confirmed that BB dip-coating does not affect the transparency of the BCNF-E050 film. Furthermore, based on the light transmittance in the 200-400 nm wavelength range, the UV-blocking efficiency was calculated. The BCNF-E050 film exhibited a UV-blocking rate of 89.8%, whereas the BCNF-E050/BB film demonstrated a significantly improved UV-blocking rate of 99.9% [FIG. 12(a)].

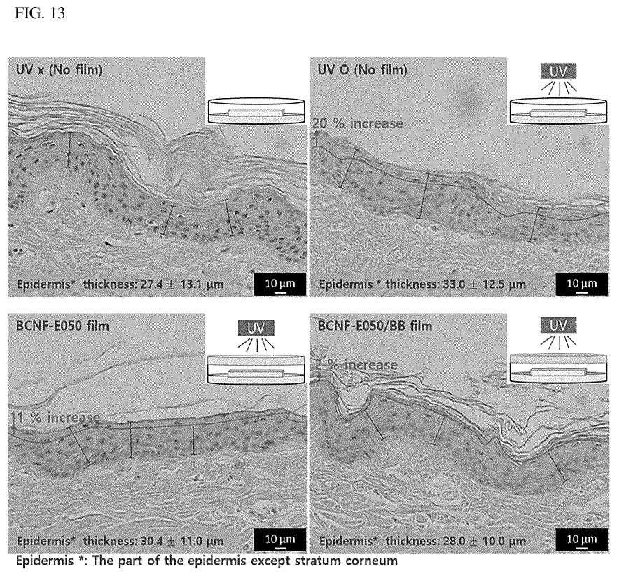

Additionally, to visually demonstrate the UV protection capability of the BCNF-E050/BB film, experiments were conducted using a UV-sensitive card and artificial skin [FIG. 12(b), FIG. 13]. In FIG. 12(a), BCNF-based films were placed over a UV-sensitive card that changes color to purple when exposed to UV light in the 200-400 nm range. The results showed that the area covered with the BCNF-E050 film turned purple, indicating UV penetration, whereas the area covered with the BCNF-E050/BB film remained white, the original color of the card. This indicates that UV light passed through the BCNF-E050 film but was effectively blocked by the BB-coated BCNF film (BCNF-E050/BB film).

Secondly, an experiment was conducted to evaluate how effectively the BCNF-based films could prevent UV-induced damage to artificial skin (FIG. 13). When artificial skin is exposed to excessive UV light, the stratum corneum (outermost layer) begins to peel off, and the thickness of the underlying epidermal layer increases. According to the results, the cross-section of skin not exposed to UV (UV X, No film) was compared with skin exposed to UV without any film (UV O, No film), and the latter showed about a 20% increase in epidermal thickness (excluding the stratum corneum). In contrast, the sample covered with the BCNF-E050 film showed an approximately 11% increase in thickness, while the sample covered with the BCNF-E050/BB film showed only a 2% increase. Moreover, the stratum corneum of the artificial skin was better preserved in the sample covered with the BCNF-E050/BB film compared to the other conditions. These results confirm that the addition of BB endowed the BCNF-E050 film with effective UV-blocking properties.

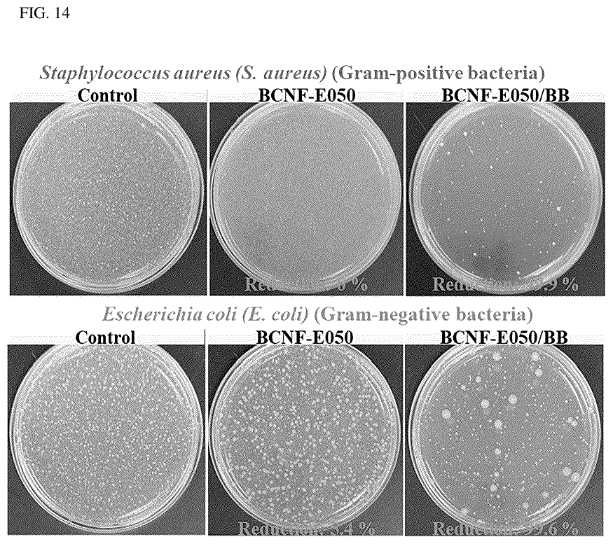

To quantitatively evaluate the antibacterial properties of the BCNF-E050/BB film, the antibacterial efficacy was analyzed using the ASTM E2149 method. According to the results, the BCNF-E050 film exhibited only 5.4% antibacterial activity against gram-negative bacteria, which is considered negligible. In contrast, the BCNF-E050/BB film showed 99.6% antibacterial activity against both gram-positive and gram-negative bacteria (FIG. 14). This strong antibacterial effect is likely due to the “contact kill” mechanism, wherein the quaternary ammonium salts in BB disrupt bacterial cell membranes upon contact, leading to bacterial death. In conclusion, the addition of BB successfully imparted antibacterial properties to the BCNF-E050 film.

After imparting various functionalities to the BCNF-E050 film through BB dip-coating, an experiment using apples was conducted to evaluate its applicability as a food packaging material.

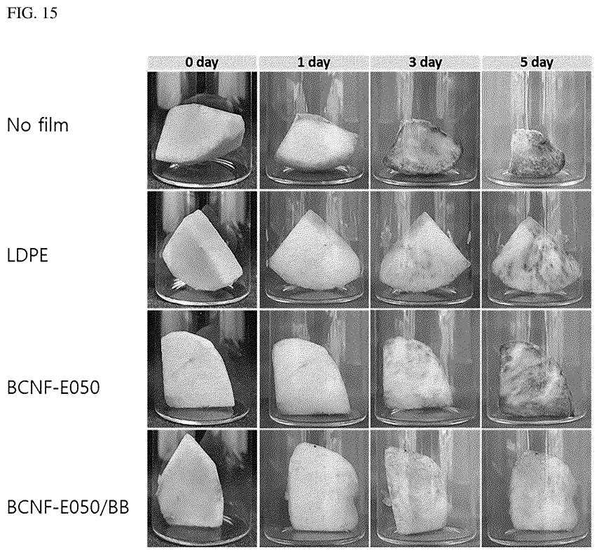

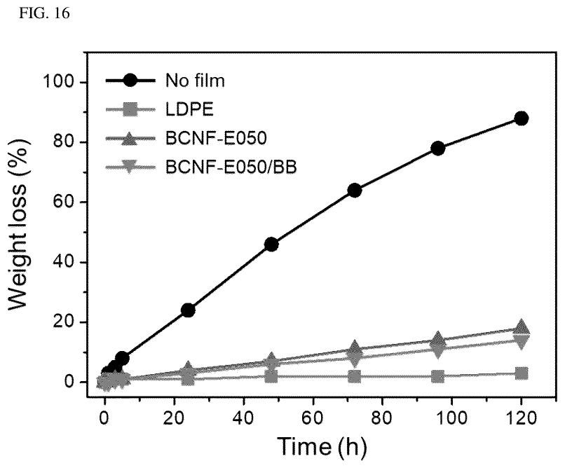

First, apples were placed in glass vials, and the vial openings were covered with LDPE, BCNF-E050 film, or BCNF-E050/BB film. Changes in the weight and color of the apples over time were then observed (FIG. 16, Table 8). The results showed that in the condition with no film covering, the apple's weight decreased by approximately 88% after 5 days, and its size was significantly reduced (FIG. 15). This indicates that moisture inside the apple had evaporated to the outside.

In contrast, in the cases where LDPE, BCNF-E050 film, or BCNF-E050/BB film were used, the weight of the apple decreased by 3˜18% even after 5 days, and there was little to no visible change in the size of the apples. This indicates that the BCNF-E050 film and the BCNF-E050/BB film were able to retain the apple's moisture similarly to LDPE.

The degree of browning of the apples under each condition was also examined to determine whether each type of film could protect the apples from external factors such as oxygen and UV. In the case of the “No film” condition, the apple had turned a deep brown color after 5 days. Comparing the apple colors before the experiment and after being covered with either LDPE or the BCNF-E050/BB film, it was observed that the apple covered with the BCNF-E050/BB film retained its original color better than the one covered with LDPE (Table 8).

These results confirm that the functionalities of the BCNF-E050/BB film, such as oxygen barrier, water vapor barrier, UV protection, and antibacterial properties, contributed to the extended preservation of the apple. Meanwhile, the BCNF-E050 film, after 5 days, exhibited significant mold growth, and the apple became so softened that even slight pressure caused it to collapse, making it impossible to measure color changes.

TABLE 8

| Sample | L* | a* | b* | ΔE* |
|---|---|---|---|---|
| No film | 77.6 ± 0.5 | 2.6 ± 0.2 | 26.6 ± 0.8 | — |
| LDPE | 47.4 ± 1.7 | 11.0 ± 0.4 | 28.0 ± 0.6 | 31.4 |
| BCNF-E050/BB | 68.4 ± 1.02 | 6.7 ± 0.3 | 32.0 ± 2.0 | 11.4 |

$$a : \vert Δ E = \sqrt{{( {L}_{0}^{*} - {L}^{*} )}^{2} + ( {a}_{0}^{*} - {a}^{*} ) 2 + {( {b}_{0}^{*} - {b}^{*} )}^{2}} ,$$

where L*₀, a*₀ and b*₀ represent the color measurement values of the apple in its natural (fresh) state.

L*, a* and b* refer respectively to brightness (from white to black), red-green chromaticity (from red to green), and yellow-blue chromaticity (from yellow to blue).

These results confirmed that BB dip-coating not only imparted hydrophobicity to the BCNF-E050 film but also provided additional functionalities such as UV-blocking and antibacterial properties. These functional properties demonstrate the potential of the BB-coated BCNF-E050 film to be used as a barrier film for applications such as food packaging.

In the above, exemplary embodiments of a functional bacterial nanocellulose film and a method for preparing the functional bacterial nanocellulose film according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

What is claimed is:

1. A method for preparing a functional nanocellulose film, the method comprising:
(a) producing bacterial nanocellulose by subjecting bacterial cellulose to electron beam irradiation and high-pressure homogenization;
(b) producing a nanocellulose film from the bacterial nanocellulose produced in step (a); and
(c) coating berberine chloride on the nanocellulose film produced in step (b).

2. The method of claim 1,
wherein the bacterial cellulose is obtained using Nata de coco.

3. The method of claim 1,
wherein step (c) comprises immersing the nanocellulose film in an aqueous solution of berberine chloride.

4. The method of claim 3,
wherein the aqueous solution of berberine chloride has a concentration of 0.1 to 10 g/L, and
wherein the immersing is performed for 10 to 40 hours.

5. The method of claim 1,
wherein in step (c), an electrostatic interaction is formed between carboxyl groups of the nanocellulose film and a quaternary ammonium group of berberine chloride.

6. The method of claim 5,
wherein the nanocellulose is represented by Chemical Formula 1, and
wherein the berberine chloride is represented by Chemical Formula 2.

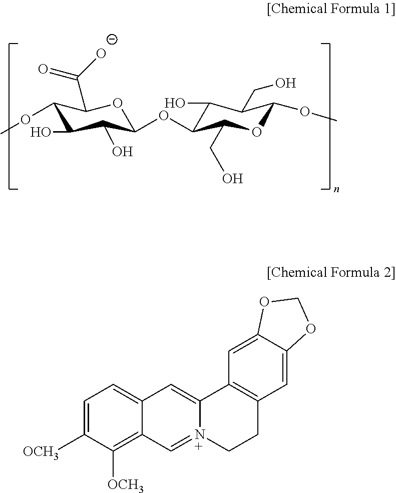

7. A functional nanocellulose film comprising a nanocellulose film coated with berberine chloride.

8. The functional nanocellulose film of claim 7,
wherein the functional nanocellulose film has a porosity reduced in comparison to that of the nanocellulose film before being coated with the berberine chloride.

9. The functional nanocellulose film of claim 7,
wherein the functional nanocellulose film has strain and stress that are increased in comparison to those of the nanocellulose film before being coated with the berberine chloride.

10. The functional nanocellulose film of claim 7,
wherein the functional nanocellulose film has oxygen permeability and water vapor permeability that are decreased in comparison to those of the nanocellulose film before being coated with the berberine chloride.

11. The functional nanocellulose film of claim 7,
wherein the functional nanocellulose film has ultraviolet transmittance that is decreased in comparison to that of the nanocellulose film before being coated with the berberine chloride.

12. The functional nanocellulose film of claim 7,
wherein the functional nanocellulose film has antibacterial activity that is increased in comparison to that of the nanocellulose film before being coated with the berberine chloride.

13. A functional packaging material comprising the functional nanocellulose film of claim 7.

14. The functional packaging material of claim 13,
wherein the functional packaging material is for food packaging use.

15. The functional packaging material of claim 13,
wherein the functional packaging material is for ultraviolet blocking use.
